(19) United States
(12) Patent Application Publication
(10) Pub. No.: US 2021/0225181 A1
(43) Pub. Date: Jul. 22, 2021

(54) DISPLAY SYSTEMS AND METHODS FOR PROVIDING GROUND TRAFFIC COLLISON THREAT AWARENESS

(71) Applicant: HONEYWELL INTERNATIONAL INC., Charlotte, NC (US)

(72) Inventors: Thea Feyereisen, Hudson, WI (US); Gang He, Morristown, NJ (US); Pramod Malviya, Bangalore (IN); Zuowei He, Shanghai (CN)

(73) Assignee: HONEYWELL INTERNATIONAL INC., Charlotte, NC (US)

(21) Appl. No.: 17/062,742

(22) Filed: Oct. 5, 2020

(30) Foreign Application Priority Data
Jan. 20, 2020 (IN) 202011002338

(51) Int. Cl. G08G 5/04; G01C 23/00; G08G 5/00

(52) U.S. Cl. CPC G08G 5/045; G08G 5/0021; G01C 23/005

(57) ABSTRACT

The present disclosure relates to aircraft display systems and methods for providing ground traffic collision threat awareness. Traffic data is received, optionally from an automatic dependent surveillance broadcast, ADSB, system, including location data for other vehicles. Threat level data is determined representing an urgency of a threat of a surface collision with another vehicle based on the traffic data. The threat level data and the location data for the another vehicle is encoded into graphical symbology for a primary flight display device and into graphical symbology for a navigation display device. The graphical symbology is displayed on the primary flight display device and on the navigation display device.

### CROSS REFERENCE TO RELATED APPLICATION

This application claims priority to Indian Provisional Patent Application No. 202011002338, filed Jan. 20, 2020, the entire content of which is incorporated by reference herein.

### TECHNICAL FIELD

The present disclosure generally relates to display systems in the flight deck of an aircraft, and also to methods for providing displays. More particularly, the displays and methods of the present disclosure are configured to provide ground traffic collision threat awareness.

### BACKGROUND

Automatic Dependent Surveillance-Broadcast (ADSB) provides positioning and velocity information for ground and air vehicles. As ground and air traffic increases, although highly unlikely, there is a resultant increase in the risk of ground collisions during taxiing, landing or takeoff.

Accordingly, there is a need in the art for a more intelligent surface alert information display format to highlight and help flight crews to visualize a ground collision threat condition to assist the crew to initiate correct and timely responsive actions. Furthermore, other desirable features and characteristics of the disclosure will become apparent from the subsequent detailed description and the appended claims, taken in conjunction with the accompanying drawings and this background of the disclosure.

### BRIEF SUMMARY

The present disclosure relates to aircraft display systems and methods for providing ground traffic collision threat awareness. Traffic data is received from an automatic dependent surveillance broadcast, ADSB, system including location data for other vehicles. Threat level data is determined representing an urgency of a threat of a surface collision with another vehicle based on the traffic data. The threat level data and the location data for the another vehicle is encoded into graphical symbology for a primary flight display device and into graphical symbology for a navigation display device. The graphical symbology is displayed on the primary flight display device and on the navigation display device.

In embodiments, systems and methods described herein provide consistent target and threat representation with respect to surface alert information display across flight deck. In embodiments, threat level data is determined representing an urgency of a threat of a surface collision with another vehicle based on the traffic data and ownship position, heading and speed.

This summary is provided to describe select concepts in a simplified form that are further described in the Detailed Description. This summary is not intended to identify key or essential features of the claimed subject matter, nor is it intended to be used as an aid in determining the scope of the claimed subject matter.

### BRIEF DESCRIPTION OF THE DRAWINGS

The present disclosure will hereinafter be described in conjunction with the following drawing figures, wherein like numerals denote like elements, and wherein:

FIG. 1 is a schematic diagram illustrating an aircraft display system for providing ground traffic collision threat awareness, in accordance with an embodiment of the present disclosure;

FIG. 2 is a flowchart of a method for providing a display for providing ground traffic collision threat awareness, in accordance with an embodiment of the present disclosure.

FIGS. 3 to 6 illustrate exemplary primary flight and navigation displays, in accordance with various embodiments of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention, which is defined by the claims. Furthermore, there is no intention to be bound by any expressed or implied theory presented in the preceding technical field, background, brief summary, or the following detailed description.

Embodiments of the present disclosure provide surface alert graphics (graphical symbology) displaying a localized geographic area of potential traffic incursion or collision rather than highlighting an entire runway. The localized geographic area is centered at the predicted location of conflicts or at the location of the target vehicle providing a source of potential traffic incursion or collision. This localized geographic area can be displayed in 2D and/or 3D view formats. A 2D display format is provided, in some embodiments, as part of a navigation display (e.g. a multifunctional navigation display) and a 3D display format is provided, in some embodiments, as part of a primary flight display (e.g. a perspective view of a primary flight display). In embodiments, the displayed localized area is of different shape and color to indicate different types of surface alerts event. For example, a yellow color area with a circular shape may be used to indicate caution type of surface alert event. Other level (e.g. urgency of threat) of events such as warning or advisory may use different shaped graphic elements and color (such as a cyan diamond shape for advisory events and a red square for warning events). The threat level of events is determined, in some embodiments, based on calculated time to potential collision. In accordance with embodiments of the present disclosure, coordinated graphical symbology is used for multifunctional and primary flight displays in terms of color and shape.

In embodiments described herein, a potential threat area location is predicted based on ownship and potential conflict target vehicle coordinates and speed of travel, altitude and path, thereby allowing time to any potential collisions to be determined. The position, attitude and speed data for other vehicle(s) (on ground or in air vehicles) is obtained from an ADSB system or other traffic information system. The location of other vehicles, where there is a potential for a collision, is made available to a display computer to place the location of the other vehicle or vehicles in lateral, map or navigation displays. Further, the time to potential collision is encoded into the above described graphical symbology representing different threat levels and included in the vertical and primary flight displays.

In some embodiments, when a surface alert is determined, the navigation display is automatically ranged to position both the potential collision point and threat target vehicle on a multi-functional display to allow clear visualization of the location of the target vehicle and predicted location of the potential collision. In some embodiments, a time scale is provided for flight crew to understand time ahead for the predicted potential collision event. The time scale to the conflicts are determined based on a measured distance at current ground speed or the predicted time to the conflict point. In some embodiments, information not immediately relevant to the alert events and conditions are selectively deemphasized or removed in order to highlight alert location and nature in the navigation display. That is, display features are decluttered for flight crews to visualize the threat clearly.

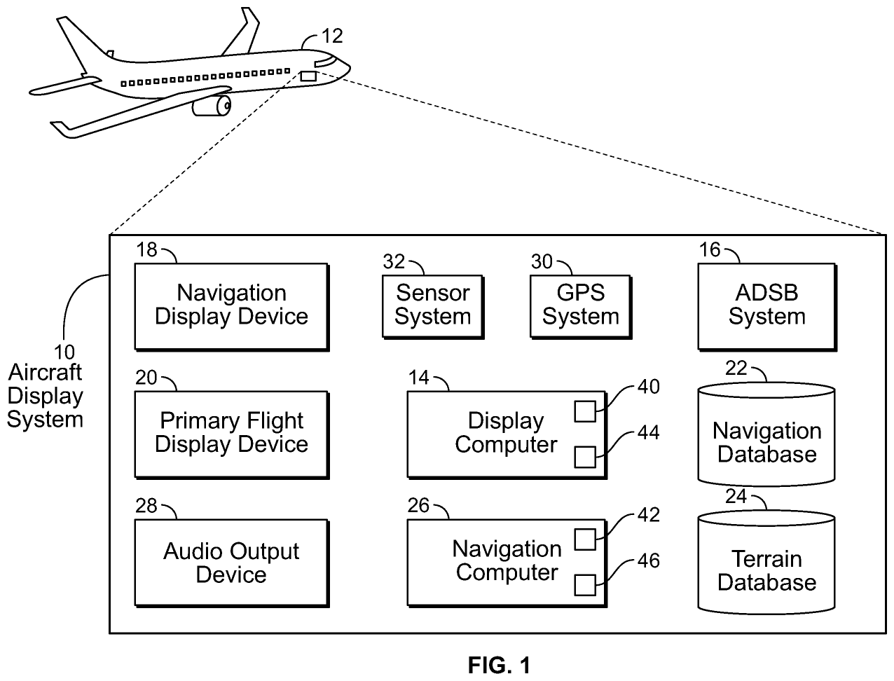

FIG. 1 provides a schematic diagram of an aircraft 12 and associated aircraft display system 10, in accordance with various embodiments. The aircraft display system 10 may be located onboard ownship aircraft 12 in some embodiments, but a remote location of some sub-systems shown in FIG. 1 is not excluded. The present embodiment of aircraft display system 10 includes, without limitation, a navigation display device 18, a primary flight display device 20, a display computer 14, a navigation computer 26, an ADSB system 16, a navigation database 22, a terrain database 24, an audio output device 28, a GPS system 30, and a sensor system 32. It should be understood that FIG. 1 is a simplified representation of an aircraft display system 10 for purposes of explanation and ease of description, and FIG. 1 is not intended to limit the application or scope of the subject matter in any way. In practice, the display system 10 and/or aircraft 12 will include numerous other devices and components for providing additional functions and features, as will be appreciated in the art.

In an exemplary embodiment, the navigation and primary flight display devices 18, 20 are coupled to the display computer 14 to display, render, or otherwise output one or more graphical representations or images associated with operation of the aircraft 12, as described in greater detail below. In an exemplary embodiment, the navigation and primary flight display device 18, 20 are realized as electronic displays configured to graphically display flight information or other data associated with operation of the aircraft 12 under control of the display computer 14, as will be understood. In an exemplary embodiment, the navigation and primary flight display devices 18, 20 are located within a flight deck/cockpit of the aircraft 12. It will be appreciated that additional display devices may be present onboard the aircraft 12. It should also be appreciated that the aircraft display system 10 under consideration is generally a cockpit display system 10. However, such an aircraft display system 10 may also provide encoded threat level data concerning potential ground collisions on mobile or other non-cockpit display systems. In embodiments described herein, the navigation display device 18 and display computer 14 are configured to provide a graphical view as though from a vertical position above the ownship aircraft 12. In embodiments described herein, the primary flight display device 20 and display computer 14 are configured to provide a graphical perspective, out-of-window, view of surroundings of the ownship aircraft 12. The navigation display device 20 thus provides a horizontal sectional view or a top down view whereas the primary flight display device 20 provides a perspective view allowing visualization of vertical dimensions. In accordance with various embodiments, the primary flight display device 20 and display computer 14 are configured to provide a 3D display, whereas the navigation display device 18 and display computer 14 are configured to provide a 2D display.

In an exemplary embodiment, the navigation computer 26 is configured to obtain one or more navigational parameters associated with operation of the aircraft 12. Navigation computer 26 is in communication with ADSB system 16 and with GPS system 30 in order to determine location of ownship aircraft 12 as well as location of other vehicles including aircraft and ground airport vehicles. Other parameters of relevance include speed and altitude of ownship aircraft 12 and that of the other vehicles. Speed and altitude of ownship aircraft 12 is available from one or more corresponding sensors in sensor system 32 and location of ownship aircraft 12 is available from GPS system 30. Further, speed, altitude and location of other vehicles (e.g. traffic data) is available via ADSB system 16, which is described in further detail below.

The navigation computer 26 is configured to process the input location, altitude and speed data vectors for the ownship aircraft 12 and other vehicles and to issue surface alerts when one or more potential ground-based collisions are predicted. In embodiments, the navigation computer 26 is configured to project a path of travel of each vehicle (based on vehicle heading and current location) and to determine a time to any interception of those paths (based on vehicle speeds). The navigation computer 26 is configured to output a different type of alert depending on different threat level of potential collision, e.g. different times to potential collision. For example, when the potential collision is 15 seconds or less away, a warning surface alert is issued. When the potential collision is 30 seconds or less (and greater than 15 seconds) away, a cautionary alert is issued. When the potential collision is 60 seconds or less away (and greater than 30 seconds), an advisory alert is issued.

In accordance with embodiments of the present disclosure, aircraft display system 10 includes ADSB system 16, by which the position of the ownship aircraft 12 is determined via satellite navigation (e.g. GPS system 30) and periodically broadcast so that other vehicles and air traffic control are able to track position of traffic. ADSB system 16 is one example of a suitable traffic information system. ADSB system 16 makes an aircraft visible, in realtime, to air traffic control (ATC) and to other appropriately equipped ADSB aircraft with position and velocity data transmitted every second. ADSB system 16 includes an ADSB Out module (not shown) and an ADSB In module (not shown). The ADSB out module allows each suitably equipped aircraft to periodically broadcast information about itself, such as identification, current position, altitude and velocity, through an onboard transmitter. The ADSB Out module provides air traffic controllers and other vehicles with real-time position, velocity and altitude information. The ADSB In module allows reception of other ADSB data (in addition to the reception by aircraft of flight and traffic information service data—FIS-B and TIS-B data) such as direct communication from nearby aircraft and other vehicles (whether on ground or in air). ADSB system 16 includes a high-integrity satellite navigation source (e.g. GPS system 30 or other certified GNSS receiver) and a datalink. There are several types of certified ADSB data links, but the most common ones operate at 1090 MHz or at 978 MHz.

In accordance with various embodiments of the present disclosure, aircraft display system 10 includes the above-mentioned navigation database 22 and terrain database 24. These databases 22, 24 are shown separately for description purposes, though they could be integrated. Navigation database 22 can be part of a Flight Managements System (FMS—not shown) of aircraft 12. The navigation database 22 contains data elements from which a flight plan is constructed. The navigation database 22 may contain data required for building a flight plan including waypoints/intersection, airways, radio navigation aids including distance measuring equipment (DME), VHF omnidirectional range (VOR), non-directional beacons (NDBs) and instrument landing systems (ILSs), airports, runways, standard instrument departure (SID), standard terminal arrival (STAR), holding patterns (only as part of IAPB—although can be entered by command of ATC or at pilot's discretion), instrument approach procedure (IAP), etc. Of particular relevance to the present disclosure is airport and runway data included in navigation database 22, which allows a map of the airport including runways, taxiways, roadways and buildings to be constructed by display computer 14 for display on navigation display device 18 and primary flight display device 20 in association with location of other vehicles based on data from ADSB system 16, via navigation computer 26. Terrain database 24 includes data elements describing ground terrain and some buildings. Thus, slopes, hills, mountains, buildings and even trees can be described in terrain database 24. Terrain database 24 allows terrain features to be included in displays generated by display computer 14, particularly three-dimensional perspective displays provided by primary flight display device 20.

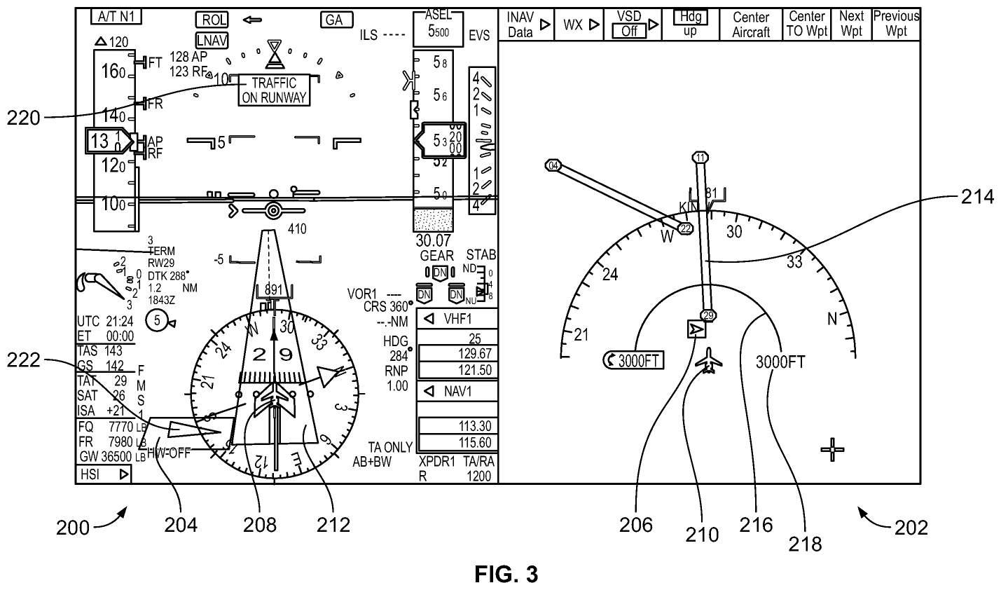

Display computer 14 is, in embodiments, responsive to the surface alerts issued by the navigation computer 26 by encoding the different type of surface alerts into graphical symbology for display on primary flight display device 20 and the navigation display device 18. In embodiments, display computer 14 is configured to encode time to potential collision (urgency data) into one of a plurality (e.g. three or more) of types of graphical symbology, which may differ from each other in shape and/or color to allow flight crew to easily grasp the urgency of the alert. Further, the location of the potential collision and/or the location of the target vehicle is indicated by the location of the graphical symbology in image space. That is, world coordinates for the location of the potential collision and/or the location of the target vehicle are received from navigation computer 26 and transformed into image space and correspondingly located in the primary flight and navigation displays. In some embodiments, altitude of the target vehicle is indicated by the graphical symbology. Further details of the graphical symbology are described below with reference to FIGS. 3 to 6.

In embodiments, navigation display device 18 and display computer 14 are configured to display the graphical symbology representing the type of surface alert and location of the surface alert in a two-dimensional view that may include airport features including at least runways and taxiways obtained from navigation database 22 and potentially also terrain features including building and trees obtained from terrain database 24. Further, primary flight display device 20 and display computer 14 are configured to display a three-dimensional perspective view including airport features including at least runways and taxiways and terrain features including ground terrain, buildings, trees, etc. In the primary flight display, the graphical symbology showing the type and location of the surface alert can also have a three-dimensional aspect (e.g. be slightly raised in appearance from the ground).

In embodiments, display computer 14 is configured to autorange the navigation display by adjusting a scale thereof to show any potential surface collision, specifically the encoded graphical symbology therefor, in full. That is, when a surface alert and associated location data from navigation computer 26 indicates a location of the target aircraft (and/or potential collision point) that is outside of the current range of the navigation display, the scale of the navigation display is increased (a zoom out function) to show the location of the target vehicle and the associated graphical symbology, graphical symbology for the ownship vehicle 12 and a location of the potential surface collision. The primary flight display, by contrast, is, in embodiments, fixed in scale in that a target vehicle outside of the current viewing range of the primary flight display is represented by only partially displaying the graphical symbology on an edge of the primary flight display. Accordingly, the navigation display autoranges, under control of the display computer 14 and based on location and alert type provided by navigation computer 26, so as to zoom in as a target vehicle and ownship get closer together (which will correspond to a shorter time to potential collision) and conversely to zoom out when the target vehicle is out of range of a current view. Corresponding zoom functions are not effected in the primary flight display under control of the display computer 14.

In embodiments, the navigation computer 26 is configured to issue a description of the type of alert in addition to location of target vehicles and time to potential collision (e.g. urgency type) such as “Traffic on taxiway”, “Traffic on runway” and “Traffic on final”. Such descriptive text is configured to be output as part of primary flight display device 20 by display computer 14 and also to be output as an auditory alert by audio output device 28 (e.g. by one or more speakers in combination with a text to speech engine).

In some embodiments, the primary flight display device 20 and the display computer 14 are configured as, or to include, a synthetic vision system (SVS). As may be recognized in the art, many aircraft are equipped with one or more vision enhancing systems. Such vision enhancing systems are designed and configured to assist a pilot when flying in conditions that diminish the view from the cockpit. One example of a vision enhancing system is known as a synthetic vision system (hereinafter, “SVS”). A “synthetic vision system” refers to a system that provides computer-generated images of the external scene topography from the perspective of the flight deck, derived from aircraft attitude, high-precision navigation solution, and terrain database 24 describing ground terrain, obstacles, and relevant cultural features. A synthetic vision system is an electronic means to display a synthetic vision depiction of the external scene topography to the flight crew. Synthetic vision creates an image relative to terrain and airport within the limits of the navigation source capabilities (position, altitude, heading, track, and the database limitations). The SVS includes or accesses the terrain database 24 containing information relating to the topography along the aircraft's flight path, such as information relating to the terrain and known man-made and natural obstacles proximate the aircraft flight path. The SVS is configured to utilize position, heading, altitude, and orientation information and the topographical information contained in the terrain database 24, and generate a three-dimensional image that shows the topographical environment through which the aircraft is flying from the perspective of a person sitting in the cockpit of the aircraft. The three-dimensional image (also referred to herein as an “SVS image”) may be displayed to the pilot on any suitable display unit accessible to the pilot. The SVS image includes features that are graphically rendered including, without limitation, a synthetic perspective view of terrain and obstacles located proximate the aircraft's flight path. Using a SVS, the pilot can look at a display screen of the display unit to gain an understanding of the three-dimensional topographical environment through which the aircraft is flying and can also see what lies ahead. The pilot can also look at the display screen to determine aircraft proximity to one or more obstacles proximate the flight path. Further, the graphical symbology representing different types of surface alerts are included in the SVS display on the primary flight display device 20.

Navigation computer 26 and display computer 14 include at least one processor 40, 42 and a computer readable storage device or media 44, 46. The at least one processor can be any custom made or commercially available processor, a central processing unit (CPU), a graphics processing unit (GPU), an auxiliary processor among several processors associated with the aircraft display system 10, a semiconductor based microprocessor (in the form of a microchip or chip set), a macroprocessor, any combination thereof, or generally any device for executing instructions. The computer readable storage device or media may include volatile and nonvolatile storage in read-only memory (ROM), random-access memory (RAM), and keep-alive memory (KAM), for example. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller aircraft display system 10 in controlling generation and display of surface alerts as described herein.

The instructions may include one or more separate programs, each of which comprises an ordered listing of executable instructions for implementing logical functions. The instructions, when executed by the at least one processor, receive and process input signals, perform logic, calculations, methods and/or algorithms for generating and display surface alerts as detailed further herein.

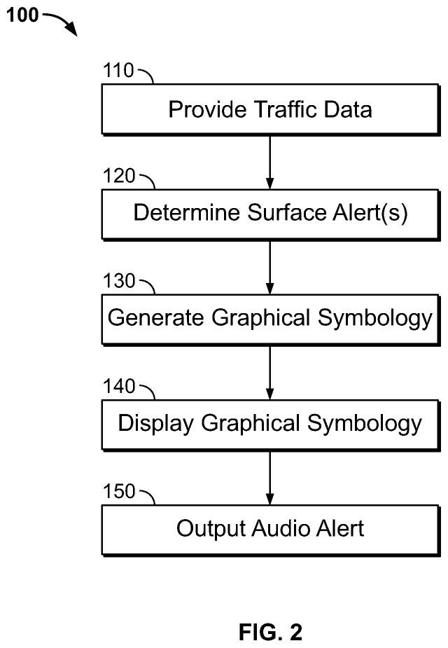

In furtherance of the foregoing disclosure, FIG. 2 is a flowchart illustrating an exemplary method 100 of displaying, in the aircraft display system 10, ground traffic threat awareness, in accordance with some embodiments of the present disclosure. In embodiments, method 100 is a computer executed method carried out by at least one processor (described further above) included as part of navigation computer 26 and/or display computer 14 and/or other avionics computers included in aircraft 12. The at least one processor executes method 100 through computer readable instructions stored on memory (described further above).

Method 100 includes a step 110 of receiving traffic data concerning other vehicles (in air and on ground vehicles) representing location, velocity and altitude. In accordance with the present disclosure, the traffic data is received through ADSB system 16, specifically through ADSB In module thereof.

In the exemplary method of FIG. 2, step 120 includes determining surface collision alerts based on the traffic data received in step 110. In embodiments, the navigation computer 26 tracks location, altitude and velocity of each outside vehicle and also tracks the path of the ownship aircraft 12 in order to project future paths of each vehicle and the ownship aircraft 12. Path projections allow the navigation computer 26 to determine any path interceptions (representing potential collisions), within a predetermined tolerance, and times to the interceptions (based on speeds of the intercepting vehicles following the projected paths). Navigation computer 26 outputs different types of surface alerts depending on time to collision (e.g. warning, caution and advisory in descending order of urgency) and associated data including location and altitude of the target vehicle that is the subject of the surface alert.

In accordance with various embodiments, method includes step 130 of generating, by the display computer 14, different graphical symbology for different types of alerts issued in step 120. That is, in embodiments, different shape and/or color graphical symbology is generated representing a coding of different times to potential collisions as calculated by navigation computer 26. Different shapes include rectangular, circular, diamond, etc. and different colors include red, yellow, cyan, etc. Further, the graphical symbology is located in image space based on location of the target vehicle or projected collision location derived from corresponding data from the navigation computer 26 generated in step 120. In accordance with various embodiments, step 130 includes autoranging, via the display computer 14 and based on data from the navigation computer 26, a scale of a navigation display so as to fit with locations of vehicles associated with any surface collision alerts generated in step 120. Autoranging can include zooming-in when the target vehicle is relatively close to the ownship aircraft 12 and zooming-out when the target vehicle is off the screen in image space of the navigation display. Further, locations of graphical symbology for any vehicle associated with a surface collision alert that is outside of a visible range of a primary flight display is presented partially on-screen at an edge of the display. In some embodiments, the navigation display is decluttered when a surface collision alert is active as compared to the navigation display before the surface alert is determined in step 120 by removing certain data elements. For example, taxiway identifiers, building identifiers, etc. are removed whereas these identifiers are included in the navigation display in the absence of a surface collision alert. Other removable information includes tower frequencies, etc. and/or any taxi instruction entry fields, etc.

In accordance with various embodiments, method 100 includes step 140 of displaying graphical symbology representing one or more surface alerts as generated in step 130. The display of graphical symbology is performed through navigation display device 18 and primary flight display device 20. In embodiments, the graphical symbology is coordinated in shape and/or color between the navigation display and the primary flight display. In accordance with various embodiments, the navigation display displayed by the navigation display device 18 includes two-dimensional graphical symbology representing location and threat type (surface alert type) of the other vehicle (or vehicles), a graphic representing the ownship aircraft 12 and its location, graphics representing airport features (e.g. runways, taxiways, buildings, etc.) and optionally graphics representing terrain features (e.g. natural or man-made obstacles such as trees, buildings and changing ground profile such as hills and slopes) obtained from databases 22, 24. Primary flight display presents, in some embodiments, similar graphical features (airport features, terrain features, surface alerts) but with a three-dimensional perspective. In some embodiments, the entire primary flight display is presented as computer generated graphics in the form of a SVS, as described above.

In embodiments, method further includes a step 150 of outputting audio alerts based on a textual description included in the surface alert data output from the navigation computer 26 in step 120. This audio alert can be generated based on text to speech processing. Further, the textual description, or a derivative thereof, can be included as a text label of the type of surface collision alert presented through primary flight display device 18.

Display method 100 and aircraft display system 10 are operable to produce navigation and primary flight displays including display features as shown in FIGS. 3 to 6, which offer exemplary embodiments of the present disclosure.

FIG. 3 illustrates a primary flight display 200 that is displayed through primary flight display device 18 and a navigation display 202 that is displayed through navigation display device 18. In the exemplary embodiment of FIG. 3, the ownship aircraft 12, and its location as derived from GPS system 30, is graphically shown by an airplane shaped symbol 208, 210 in both the primary and navigation displays. Further, navigation computer 26 has calculated a time to a potential collision with a ground based target vehicle within a first time range (e.g. less than 15 seconds) associated with a first type of surface collision alert. First time range is shorter than second and third time ranges (e.g. less than 30 and 60 seconds, respectively) associated with second and third types of surface collision alert. The time to potential collision is calculated based on current speed of ownship aircraft 12 and target vehicle and their projected paths.

The navigation computer 26 has selected a surface alert type corresponding to the first time range, which in this case is a warning surface alert type. In response thereto, display computer 14 generates a corresponding type of graphical symbology 204, 206, which in this case is a square or rectangle underlying (e.g. in the style of a carpet) a symbol for the target vehicle 222 (e.g. an arrowhead shape) that is colored red. The graphical symbology 204, 206 corresponding to a warning alert of the same type, in terms of shape, style and/or color, is shown in both the primary flight display 200 and the navigation display 202. However, the graphical symbology 204 in the primary flight display 200 has a raised or three-dimensional aspect whereas the graphical symbology 206 for the navigation display appears two-dimensional.

Further, in exemplary embodiments, primary flight display 200 includes a text label 220 (in this exemplary case “TRAFFIC ON RUNWAY”) derived from descriptive metadata associated with surface collision alert provided by navigation computer 26. The text label 220 is provided with a background color to match the color of the square or rectangle of the graphical symbology (e.g. red) to indicate the type (e.g. urgency) of the surface collision alert. This textual data is output as speech audio from audio output device 28.

In various embodiments, navigation display 202 includes distance or timescales including a ring or part ring 216 around the ownship aircraft symbol 210 representing an equidistant or equal time scale. The distance or timescale further includes a time or distance scale value (e.g. 3000 feet in this example) so that the crew can readily grasp a distance or time to the potential collision with target vehicle. In embodiments, the range or scale of the navigation display 202 is auto adjusted depending on distance or time to potential collision. In some embodiments, the navigation and primary flight displays further include airport features such as runways 212, 214 based on data from navigation database 22. Further, terrain features are included in primary flight display 200 based on data from terrain database 24.

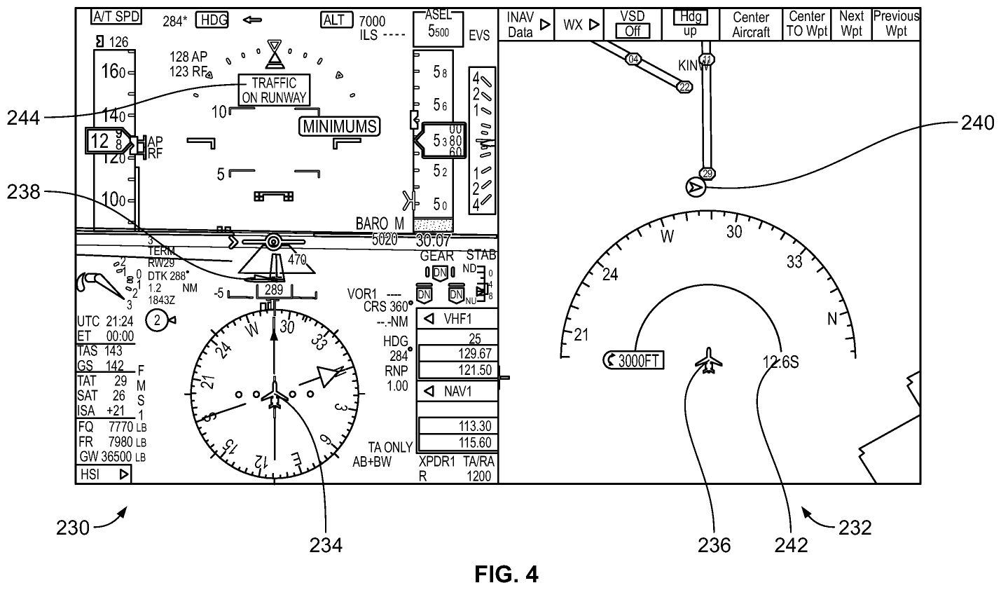

FIG. 4 illustrates another exemplary embodiment of a primary flight display 230 and a navigation display 232. In the present embodiment, navigation computer 26 has calculated a time to a potential collision with a target vehicle that is within a second time range (e.g. less than 30 seconds but more than 15 seconds). The time to potential collision is calculated based on respective speeds and projected paths of the ownship aircraft 12 and the target vehicle. Navigation computer 26 has issued a type of surface collision alert corresponding to the second time range, specifically a warning alert. Display computer 14 is responsive to the surface collision alert by generating a corresponding type of graphical symbology in terms of shape (in the present example, the shape is circular) and color (in the present example, the color is yellow). The graphical symbology 238, 240 is located in image space at a position corresponding to the location of the target vehicle in world coordinates. The shaped area (circular in this exemplary case) underlies a symbol for the target vehicle. A graphic 234, 236 representing the ownship aircraft 12, and its location, is provided in primary flight display 230 and in navigation display 232. Further, a text label 244 is displayed in primary flight display 230, which is derived from a description included in metadata associated with the surface collision alert from the navigation computer 26. The text label 244 has a background color (yellow in this exemplary case) that is the same as the shaped area of the graphical symbology 238, 240. Navigation display 232 includes a scale indicator that includes a timescale 242, which is based on distance scale of autoranged navigation display 232 and speed of ownship aircraft 12.

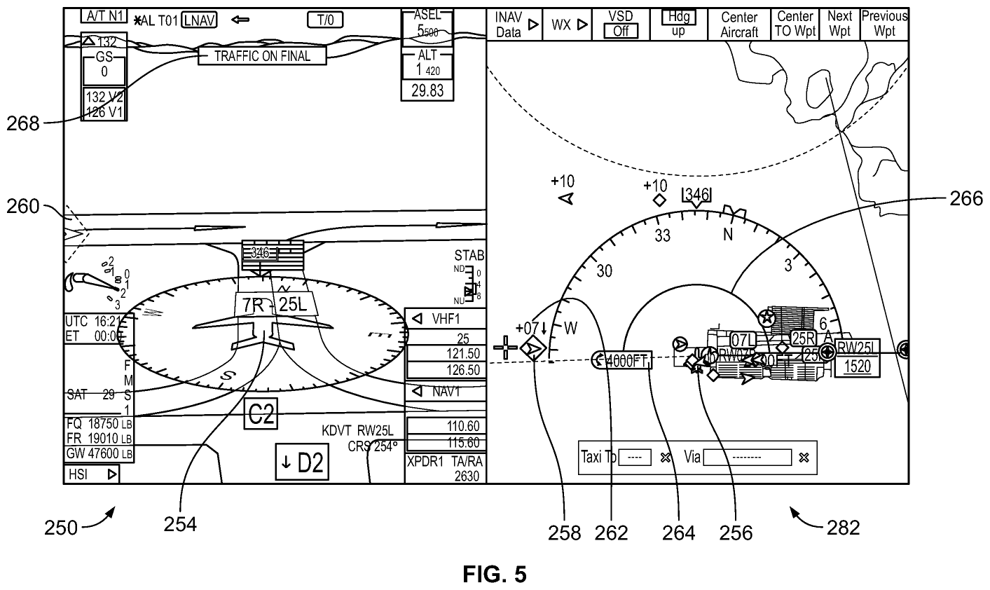

FIG. 5 illustrates a primary flight display 250 and a navigation display 252 in accordance with an exemplary embodiment. In the present embodiment, the navigation computer 26 has calculated time until a potential collision that falls within a third time range (less than 60 second and greater than 30 seconds) and has output a corresponding type (or urgency type) of surface collision alert, specifically an advisory alert in the present example. Display computer 14 is responsive to the alert type to generate a type of graphical symbology 258, 260 in terms of shape and color that corresponds to the alert type. In the present example, the advisory alert is presented by graphical symbology 260, 258 including a diamond shaped area that is colored cyan underlying a graphic (e.g. an arrowhead) to indicate the target vehicle. Further, the graphical indicator is positioned in image space in a way that corresponds to the global position of the target vehicle. In the present example, the ownship aircraft 12 is located on the ground (as indicated by aircraft graphics 254, 256) and the target vehicle is in the air, whereas in the examples of FIGS. 3 and 4, the ownship aircraft 12 is in the air and the target vehicle is on the ground.

In the exemplary embodiment of FIG. 5, the display computer 14 has autoranged the navigation display 252 to a greater distance scale (e.g. from the inner part ring 226 distance scale indicator representing 3000 feet in FIGS. 3 and 4 to the inner part ring 226 representing 4000 feet in FIG. 5) in order to make fully visible the graphical symbology 258 for the target vehicle. In the primary flight display 250, the location of the target vehicle in image space is outside the view range of the primary flight display 250. Instead of autoranging, the primary flight display 250 illustrates only part of the graphical symbology 260 at an edge of the primary flight display, where the edge corresponds to a location of the target vehicle. In the exemplary embodiment of FIG. 5, the graphical symbology additionally indicates an altitude of the target vehicle (e.g. in the form of an altitude value displayed above the shaped area of the graphical symbology 258) and whether the target vehicle is ascending or descending (e.g. in the form of an up arrow or a down arrow) by additional indicator 262. Altitude and ascending or descending status of the target vehicle is determinable by the navigation computer 26 based on data provided through ADSB system 16. In the present example, the primary flight display 250 includes a text label 268 (e.g. “TRAFFIC ON FINAL”) that has a background color (e.g. cyan) that is the same as that of the color of the shaped area of the graphical symbology 260, 258.

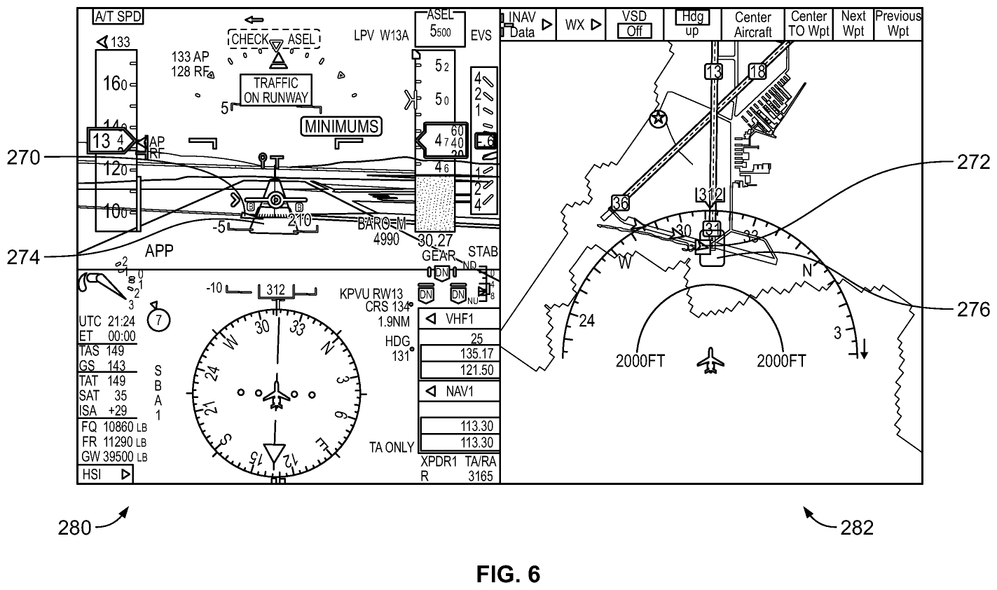

FIG. 6 illustrates another exemplary embodiment of a primary flight display 280 and a navigation display 282. This embodiment is similar to that of FIG. 2 in that navigation computer 26 has determined a warning alert based on a target vehicle having a projected movement that coincides with a projected movement of the ownship aircraft 12 on the runway. The exemplary display of FIG. 6 differs from that of FIG. 3 in that the shaped area 274, 276 (e.g. square/rectangular for warning, circular for caution, diamond for advisory) is centered on a projected position of potential collision rather than centrally underlying the graphic 270, 272 indicating the target vehicle.

In all of the embodiments of FIGS. 3 to 6, terrain features can be included in one or both of the primary flight display and the navigation display as can airport features, as described further herein.

The use cases and the depictions provided here are only exemplary in nature. It should be possible to use different symbology and semantics to accomplish the same concepts described herein.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. Various changes may be made in the function and arrangement of elements described in an exemplary embodiment without departing from the scope of the invention as set forth in the appended claims.

What is claimed is:

1. An aircraft display system for providing ground traffic collision threat awareness, comprising:
a primary flight display device;
a navigation display device;
at least one processor in operable communication with the primary flight display device and the navigation display device, the at least one processor configured to:
receive traffic data that includes location data for other vehicles;
determine threat level data representing an urgency of a threat of a surface collision with another vehicle based on the traffic data;
encode the threat level data and the location data for the another vehicle into graphical symbology for the primary flight display device and into graphical symbology for the navigation display device;
display the graphical symbology on the primary flight display device; and
display the graphical symbology on the navigation display device.

2. The aircraft display system of claim 1, wherein the traffic data includes location data and speed data of the other vehicles and wherein the at least one processor is configured to determine the threat level data by including the steps:
calculating interception data by projecting paths of ownship and the other vehicles based at least on location data and speed data of ownship and location data and speed data of the other vehicles included in the traffic data and determining path projections that intercept;
determining the threat level data based on the interception data.

3. The aircraft display system of claim 2, wherein the interception data includes time to interception data of the ownship and the another vehicle, wherein the threat level data is encoded into different graphical symbology depending on the time to interception data.

4. The aircraft display system of claim 1, wherein the at least one processor is configured to encode the threat level data for the another vehicle into different shape and/or different color graphical symbology depending upon the urgency of the threat of the surface collision with the another vehicle.

5. The aircraft display system of claim 1, wherein the at least one processor is configured to encode the location data for the another vehicle by transforming the location data from world space to image space and correspondingly positioning the graphical symbology.

6. The aircraft display system of claim 1, wherein the at least one processor is configured to autorange the navigation display based on the location data of the another vehicle so as to present the graphical symbology in full.

7. The aircraft display system of claim 6, wherein the at least one processor is configured to present only part of the graphical symbology at a border of the primary flight display based on the location data of the another vehicle being off-screen in image space.

8. The aircraft display system of claim 1, wherein the graphical symbology includes a graphical representation of the another vehicle and a graphical shaped carpet underneath the graphical representation of the another vehicle, wherein the threat level data and the location data is encoded in the shape, position and color of the graphical shaped carpet.

9. The aircraft display system of claim 1, wherein the graphical symbology includes a graphical representation of the another vehicle and a graphical shaped threat zone, wherein the threat level data and the location data is encoded in the shape, position and color of the graphical shaped threat zone, and wherein the threat zone is positioned in image space to correspond to a projected collision point of ownship and the another vehicle.

10. The aircraft display system of claim 1, wherein the at least one processor is configured to determine a type of threat and to display a textual label of the type of threat on the primary flight display.

11. The aircraft display system of claim 1, wherein the at least one processor is configured to:
determine first threat level data when a first time to surface collision with the another vehicle is calculated based on the traffic data;
determine second threat level data when a second time to surface collision with the another vehicle is calculated based on the traffic data;
determine third threat level data when a third time to surface collision with the another vehicle is calculation based on the traffic data;
wherein the first, second and third times are different; and
wherein the first, second and third threat level data is encoded into graphical symbology using different colors and different shapes.

12. The aircraft display system of claim 1, wherein a time scale is presented on the primary flight display.

13. The aircraft display system of claim 1, wherein the at least one processor is configured to provide a three dimensional perspective view for the navigation display including terrain and airport features and the graphical symbology.

14. The aircraft display system of claim 1, wherein the at least one processor is configured to encode into the graphical symbology whether the another vehicle is in air or on ground.

15. A method for providing ground traffic collision threat awareness in an aircraft display system comprising a primary flight display device and a navigation display device, the method comprising:
receiving, via at least one processor, traffic data including location data for other vehicles;
determining, via at least one processor, threat level data representing a time to a surface collision with another vehicle based on the traffic data;
encoding, via at least one processor, the threat level data and the location data for the another vehicle into graphical symbology for the primary flight display device and into graphical symbology for the navigation display device;
displaying the graphical symbology on the primary flight display device; and
displaying the graphical symbology on the navigation display device.

16. The method of claim 15, wherein the threat level data for the another vehicle is encoded into different shape and different color graphical symbology depending upon the time to the surface collision with the another vehicle

17. The method of claim 15, comprising autoranging the navigation display based on the location data of the another vehicle so as to present the graphical symbology in full and presenting only part of the graphical symbology at a border of the primary flight display based on the location data of the another vehicle being off-screen in image space.

18. The method of claim 17, wherein a time scale is presented on the autoranged navigation display.

19. The method of claim 15, wherein the graphical symbology includes a graphical representation of the another vehicle and a graphical shaped carpet underneath the graphical representation of the another vehicle, wherein the threat level data and the location data is encoded in the shape, position and color of the graphical shaped carpet.

20. The method of claim 15, wherein the graphical symbology includes a graphical representation of the another vehicle and a graphical shaped threat zone, wherein the threat level data and the location data is encoded in the shape, position and color of the graphical shaped threat zone, and wherein the threat zone is positioned in image space to correspond to a projected collision point of ownship and the another vehicle.
